(19) United States
(12) Patent Application Publication
(10) Pub. No.: US 2026/0235159 A1
(43) Pub. Date: Aug. 13, 2026

(54) GAS FOIL BEARING STRUCTURE FOR REDUCING OPERATING TEMPERATURES

(71) Applicant: Blue Origin Manufacturing, LLC, Huntsville, AL (US)

(72) Inventors: Behzad Zamanian Yazdi, Palos Verdes, CA (US); Dimitri Germain Lieve Deserranno, Enfield, NH (US); Paul Lemke, Lakeland, FL (US); Marshall Saville, Palos Verdes Estates, CA (US)

(21) Appl. No.: 19/050,802

(22) Filed: Feb. 11, 2025

(51) Int. Cl. F16C 17/24; F16C 17/02; F16C 17/04; F16C 33/12

(52) U.S. Cl. CPC F16C 17/243; F16C 17/024; F16C 17/042; F16C 33/121; F16C 2204/10; F16C 2204/20; F16C 2204/40

(57) ABSTRACT

Gas foil bearings that are configured to have thermal conductive paths that allow for efficient conduction of heat away from the bearing gap between the bearing and a shaft therein are presented. Some techniques for carrying away heat involve a flow of a cooling fluid through the bearing. In contrast, embodiments are directed to techniques that involve configuring thermal conduction of various parts of the bearing so that the bearing may be cooled at a relatively high level of efficiency without the use of a circulating cooling fluid. A gas foil bearing may utilize cutouts on specific locations/areas of its bump foil structure. Such cutouts may lead to a uniform temperature in the bearing film by optimizing heat conduction through bump foil elements.

### BACKGROUND

Gas foil bearings are a type of fluid film bearing that relies on a thin layer of gas (often air) to support rotating shafts in high-speed machinery. Unlike traditional bearings that use oil or grease as lubricants, gas foil bearings utilize a flexible foil structure that creates a gas cushion between the moving parts. This gas film allows for near-frictionless operation, making gas foil bearings ideal for applications in high-performance equipment like gas turbines, compressors, jet engines, and other machinery where minimal friction and high efficiency are important. The absence of oil lubrication also reduces the risk of contamination or breakdown in extreme environments.

Gas foil bearings are particularly valued in high-speed and high-temperature applications because they can tolerate extreme conditions while offering low friction and minimal maintenance. These bearings are widely used in the aerospace industry, energy generation, and turbo machinery, where their ability to operate at thousands of RPMs without overheating is critical. The design, which often includes a combination of top and bump foils, allows the bearing to flex under load and adjust to misalignments or deformations during operation.

However, there is still room for improvement of gas foil bearings, particularly when it comes to managing heat and optimizing their performance in extreme conditions. Demand continues for more advanced materials and technologies that can enhance gas foil bearings'reliability and efficiency. Thus, there remains a need for better solutions to address the thermal challenges these bearings face.

### SUMMARY

Gas foil bearings are presented with thermal conductive paths designed to efficiently conduct heat away from the bearing gap between the bearing and the shaft. While some techniques rely on a flow of cooling fluid through the bearing to remove heat, the embodiments described here focus on enhancing thermal conduction within various parts of the bearing itself. This approach allows for highly efficient cooling without the need for circulating cooling fluids. A gas foil bearing can achieve this by incorporating cutouts at specific locations in its bump foil structure. These cutouts optimize heat conduction through the bump foil elements, resulting in a more uniform temperature distribution within the bearing film.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 is a schematic cross-section view of a cryogenic turboalternator with a shaft that is supported by gas foil bearings, according to some embodiments.

FIG. 2 is a schematic cross-section view illustrating heat flow in a cryogenic turboalternator, according to some embodiments.

FIG. 3 is a schematic cross-section view illustrating heat flow in a gas foil bearing, according to some embodiments.

FIG. 4 is an axial view of a gas foil thrust bearing and illustrates example isotherms on a top foil, according to some embodiments.

FIG. 5 is an axial view of a gas foil thrust bearing with a detailed view of the bump foil, according to some embodiments.

FIG. 6 is an axial view of a gas foil thrust bearing with a detailed view of the bump foil, according to other embodiments.

FIG. 7 is an axial view of a gas foil journal bearing, according to some embodiments.

FIG. 8 is a perspective view of a bump foil of a gas foil journal bearing, according to some embodiments.

FIG. 9 is a perspective view of a bump foil that includes cutouts, according to some embodiments.

### DETAILED DESCRIPTION

This disclosure describes gas foil bearings that are configured to have thermal conductive paths that allow for efficient conduction of heat away from the bearing gap between the bearing and a shaft therein. For example, the bearing gap between a top foil and a rotating shaft may be filled with a gas. As the shaft rotates, heat is generated inside the bearing gap and a cooling mechanism is generally used to carry away this heat. Some techniques for carrying away the heat involve a flow of a cooling fluid (e.g., cold gas) through the bearing. In contrast, embodiments herein are directed to techniques that involve configuring thermal conduction of various parts of the bearing so that the bearing may be cooled at a relatively high level of efficiency without the use of a circulating cooling fluid (though such a cooling fluid may be used in some of the embodiments). For example, a gas foil bearing may utilize cutouts on specific locations/areas of its bump foil structure. Such cutouts may lead to a uniform temperature in the bearing film by optimizing heat conduction through bump foil elements. The cutouts may also help to ensure a uniform bearing gap as the areas of higher pressure on the top foil may have more bump foil support thereunder. Resultantly, top foil deflection, as well as heat distribution, due to bearing film pressure may be substantially uniform.

A gas foil bearing is a type of fluid film bearing that operates using a thin layer of gas, such as air or a cryogenic gas, to provide a low-friction interface between rotating and stationary components. These bearings are particularly suited for high-speed and high-temperature applications, where traditional bearings, which use oil or grease as lubricants, for example, may fail or degrade.

The structure of a gas foil bearing includes foils, which are relatively thin, flexible layers of material, including a top foil and a bump foil. The top foil interfaces with the rotating shaft, while the bump foil, positioned beneath the top foil, provides elastic support and helps absorb mechanical stresses. As explained herein, the bump foil also absorbs heat from the top foil. In some implementations, material of the foils may be beryllium copper, which has a thermal conductivity that is higher than that of stainless steel, for example. These foils support a rotating shaft and form a gap where the gas film develops during operation. As the shaft rotates, gas is drawn into the gap, creating a cushion that separates the moving and stationary parts, thus reducing friction. The foil structure allows the bearing to accommodate slight deformations and distribute the load evenly across the bearing surface, though some areas of the foil may likely operate hotter than other areas due to load unevenness that gives rise to pressure differences.

Gas foil bearings may be either the journal type or the thrust type. A journal-type gas foil bearing supports radial loads, meaning it supports the rotating shaft in the radial direction. In this type of bearing, the shaft is surrounded by foils that are arranged in a cylindrical shape. When the shaft rotates, gas is pulled into the narrow gap (e.g., bearing gap) between the shaft and the top foil, creating a thin gas film that supports the load. The bump foil beneath the top foil provides elastic support and absorb the mechanical stresses during operation. The flexibility of the bump foil allows the bearing to adapt to thermal expansion or variations in load.

A thrust-type gas foil bearing is designed to handle axial loads, which are forces applied along the axis of the rotating shaft. In this configuration, the foils are arranged to support the shaft from the end, preventing axial movement. As the shaft rotates, a thin gas film forms between the foils and a thrust collar or disk attached to the shaft, creating a cushion that supports the axial load. The bump foil layer in thrust bearings provides the necessary flexibility to allow the top foil to conform to the shaft's movement while distributing the load evenly across the bearing surface, though some areas of the bearing surface may likely operate hotter than other areas due to load unevenness that gives rise to pressure differences. Thrust bearings may be used in conjunction with journal bearings to provide both radial and axial support.

The bump foil structure of a gas foil bearing includes bumps, a portion of which maintains contact with the underside of the top foil. The areas between the raised bumps are herein referred to as “valleys” (“troughs” may also be used in some literature). These valleys are the lower sections of the corrugated foil that alternate with the bumps, allowing the top foil to flex and conform to varying loads. The bumps provide the spring-like support, while the valleys between them create space for the necessary deformation of the bumps under pressure.

In some embodiments, a gas foil bearing comprises a top foil that includes a high pressure zone and a low pressure zone. For example, the top foil includes regions that, during operation, may be subjected to varying pressure, wherein certain regions experience higher pressure and other regions experience lower pressure. Herein, “high pressure zone” and “low pressure zone,” referring to regions of the top foil in the gas foil bearing, distinguish between the regions based on their respective different pressure (and temperature) levels during operation. In other words, these terms are used to differentiate between areas that experience different loads and concomitant temperatures.

In particular, the high pressure zone includes areas of the top foil that may be configured to operate at a first pressure and a first temperature and the low pressure zone includes areas of the top foil that may be configured to operate at a second pressure and a second temperature. Here, the first pressure and the first temperature are larger than the second pressure and second temperature.

The gas foil bearing may also comprise a bump foil that is configured to have a larger area of contact with the top foil in the high pressure zone as compared to a small area of contact with the top foil in the low pressure zone. This is explained in detail below. In some implementations, the larger area of contact of the bump foil with the top foil comprises bumps that are among valleys of the bump foil. In other implementations, the larger area of contact of the bump foil with the top foil comprises bumps that are between or among cutouts of the bump foil.

In some embodiments, a gas foil bearing comprises a top foil including a high pressure-high temperature zone and a low pressure-low temperature zone, and a bump foil including i) first bumps in contact with the high pressure-high temperature zone of the top foil, ii) second bumps in contact with the low pressure-low temperature zone of the top foil, and iii) valleys that partition each of the first bumps and each of the second bumps from one another. Here, the sizes of the first bumps are larger than sizes of the second bumps.

The thermal conductivity provided by the first bumps may be larger than the thermal conductivity provided by the second bumps. At least some of the valleys comprise cutouts or slots in the bump foil. For embodiments involving a thrust bearing, the cutouts or slots may progressively widen with increasing distance from the axial center of the thrust bearing. The cutouts or slots may be aligned in a radial direction from the axial center of the thrust bearing. For embodiments involving a journal bearing, the cutouts or slots may be aligned circumferentially with respect to the axial center of the journal bearing.

In some implementations, gas foil bearings may be used in turboalternators and turbocompressors. Gas foil bearings can provide relatively high load capacity and stability for operating at very high speeds and over a wide range of temperatures (e.g., 20 to 500 Kelvin). Gas foil bearings are configured to resist bearing failure of the turboalternator at cryogenic temperatures with high radial and axial loads. Moreover, the gas foil bearings may allow for an increase in the efficiency of the turboalternator, resulting in higher power regeneration and an overall increase in efficiency and lower power consumption of the cryocooler system in which the turboalternator is operating. In contrast, turboalternators utilizing other types of gas bearings, such as herringbone groove gas journal bearings, tilting pad gas journal bearings, and spiral groove gas thrust bearings, may have lower load capacities that result in reduced reliability of the turboalternator. Moreover, those bearing technologies may present a number of difficulties for manufacturing because they rely on tight tolerances and relatively complicated manufacturing processes. Manufacturing processes for turboalternators utilizing gas foil bearings may avoid such difficulties and complications.

The turboalternator may be used in a reverse Brayton cycle cryocooler, for example, which operates by expanding cryogenic fluid and recovering the expansion energy by converting it to electricity. A high-pressure cryogenic fluid, such as gaseous helium (GHe) may enter the turboalternator and be directed to the turbine impeller. As the high-pressure fluid expands through the impeller, it spins the impeller. The impeller is attached to a shaft which has a permeant magnet embedded in it. The shaft may be supported radially with gas foil journal bearings and supported axially with gas foil thrust bearings. The magnet is enclosed by a stationary stator winding. The spinning turbine impeller rotates the shaft and the magnet inside the stator and generates electrical current in the stator wires.

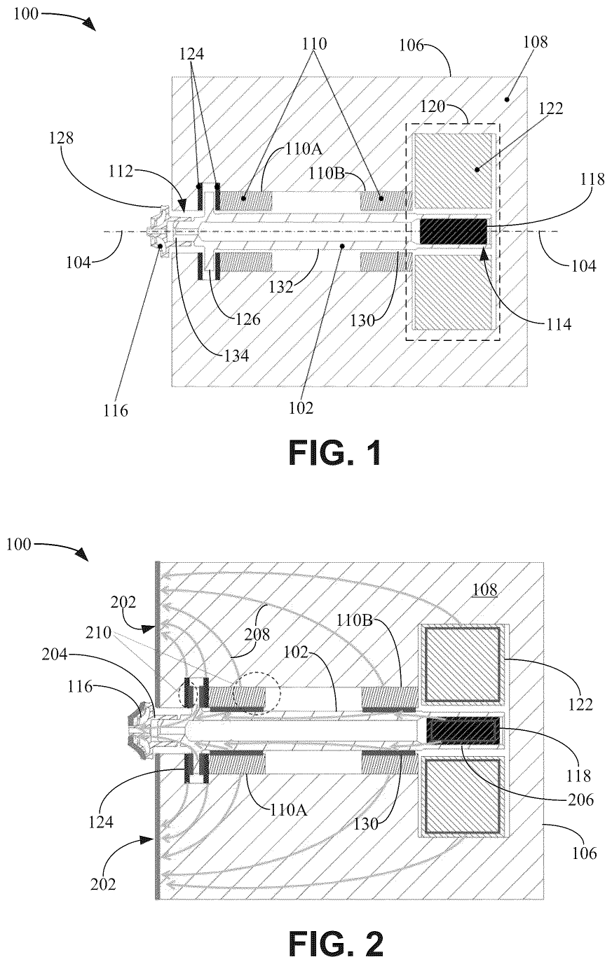

FIG. 1 is a schematic cross-section view of a cryogenic turboalternator 100 with a shaft 102 that is supported by gas foil bearings, according to some embodiments. Dimensions of the various parts of turboalternator 100 are not necessarily illustrated to scale. There may be a substantial symmetry between an upper portion of the turboalternator above an axis 104 and a lower portion of the turboalternator below axis 104. A housing 106 comprising a thermally conductive material 108 may enclose and support various elements of the cryocooler. For example, housing 106 may contain an alternator stator, shaft 102, and gas foil journal bearings 110 that are configured to be primarily cooled via heat conduction through material 108 of the housing and the shaft, as explained below.

In some embodiments, shaft 102 includes a first end 112 and a second end 114 that is opposite the first end. An impeller 116 is at the first end of the shaft and configured to spin with the shaft. Journal bearings 110 may include a first journal bearing 110A and a second journal bearing 110B. The first journal bearing may be closer than the second journal bearing to first end 112 of the shaft. Also, the second journal bearing may be closer than the first journal bearing to second end 114 of the shaft. First journal bearing 110A may substantially support first end 112 of shaft 102 and second journal bearing 110B may substantially support second end 114 of the shaft, though both bearings support the shaft to some degree. An alternator magnet 118 may be a permanent magnet(s) on the second end of the shaft. Like the impeller, the permanent magnet, which is part of an alternator 120 that includes a stator 122, is configured to spin with the shaft. The permanent magnet overhangs on the shaft with respect to the first and the second journal bearings. As mentioned above, the cryogenic turboalternator may be configured to operate in a reverse-Brayton cycle cryocooler.

Cryogenic turboalternator 100 may further comprise gas foil thrust bearings 124 to axially support shaft 102 via a radially protruding portion 126 (e.g., thrust collar) of the shaft.

A nozzle 128 on an input side of impeller 116 may be configured to provide a cryogenic working fluid to impeller 116. A cavity (not illustrated) on an output side of the impeller may be configured to receive the cryogenic working fluid from impeller 116 and allow the cryogenic working fluid to expand (e.g., a pressure drop).

Bearing cavities 130, which include an annular region from a surface 132 of shaft 102 to the first and the second journal bearings, respectively, may be configured to receive a portion of the cryogenic working fluid, which may be helium gas, for instance, that is provided to impeller 116 during operation of turboalternator 100. For example, the bearing cavities may be pressurized by the cryogenic working fluid such that pressure of the cryogenic working fluid applied to impeller 116 is also applied to the bearing cavities. In some implementations, bearing cavities 130 may be deadheaded to prevent flowthrough of the cryogenic working fluid. For example, the bearing cavities and any connecting volumes that can fill with working fluid may not be connected to any exit such that the only way for working fluid to exit these volumes is via a path 134 taken originally by the working fluid to enter these volumes. Path 134 may originate at or near impeller 116. Accordingly, the bearing cavities may be configured to be pressurized by the cryogenic working fluid that is present at nozzle 128 such that the pressure of the cryogenic working fluid applied to impeller 116 is also applied to the bearing cavities. The complete amount of pressurization may not occur, however, until after the bearing cavities are filled by an inrushing flow of working fluid subsequent to an initial startup of the cryocooler.

FIG. 2 is a schematic cross-section view illustrating heat flow in cryogenic turboalternator 100, according to some embodiments. Generally, heat may flow, as indicated by arrows 202, through the foil structure of the gas foil bearings, into the gas foil bearing housing, and then though the alternator housing to a heat sink and into a cryogenic working fluid. If the working fluid is at a cryogenic temperature, thermal equilibrium and steady state temperature of the gas foil bearings and alternator may be within an acceptable range. In the particular layout of cryogenic turboalternator 100, the alternator is moved outside of the gas foil journal bearings to help ensure that both gas foil journal bearings (e.g. 110A and 110B) are in the proximity of the heat sink and are operating at matching temperatures.

As described above, heat may flow from various sources of heat in the cryogenic turboalternator to areas that are maintained at a relatively cold state by flow of the cryogenic working fluid. These cold areas may be at or near impeller 116, nozzle 128, and the general area around the input side of impeller 116 and the cavity (not illustrated) on the output side of impeller 116, which receives the cryogenic working fluid from the impeller 116 during operation. These general cold areas are indicated by arrows 202.

The various sources of heat in cryogenic turboalternator 100 are, among other things, bearing cavities 130, which experience frictional shear forces in the lubricating fluid (e.g., the working fluid) therein while shaft 102 spins. The friction leads to heat generation in the bearing cavities of the first and the second journal bearings, as well as those of thrust bearings 124.

During operation of the turboalternator, alternator 120, which includes magnet 118 and stator 122, generates electricity via the magnetic interaction between the stator and the spinning magnet(s) on shaft 102. This magnetic interaction and the resulting generated electricity create heat. Even so, the bearings may generate a greater amount of heat compared to alternator 214. Thus, it may likely be beneficial to locate both of the bearings closer than the alternator to the general cold areas (e.g., 202), which can act as a heat sink. Because alternator 120 may likely generate a smaller amount of heat as compared to journal bearings 110, the alternator may be located further than the journal bearings from the cold regions. In other words, first journal bearing 110A and second journal bearing 110B are closer than the alternator to the impeller. Relatively speaking, first journal bearing 110A substantially supports a first end 204 of shaft 102 and second journal bearing 110B substantially supports a second end 206, which includes alternator 214.

As arrows 208 indicate, heat from these various heat sources flows to cold areas 202 via the thermally conductive material 108 of housing 106. Heat conduction is facilitated, in part, by thermal contact between the housing and the journal and thrust bearings, as indicated by dashed regions 210.

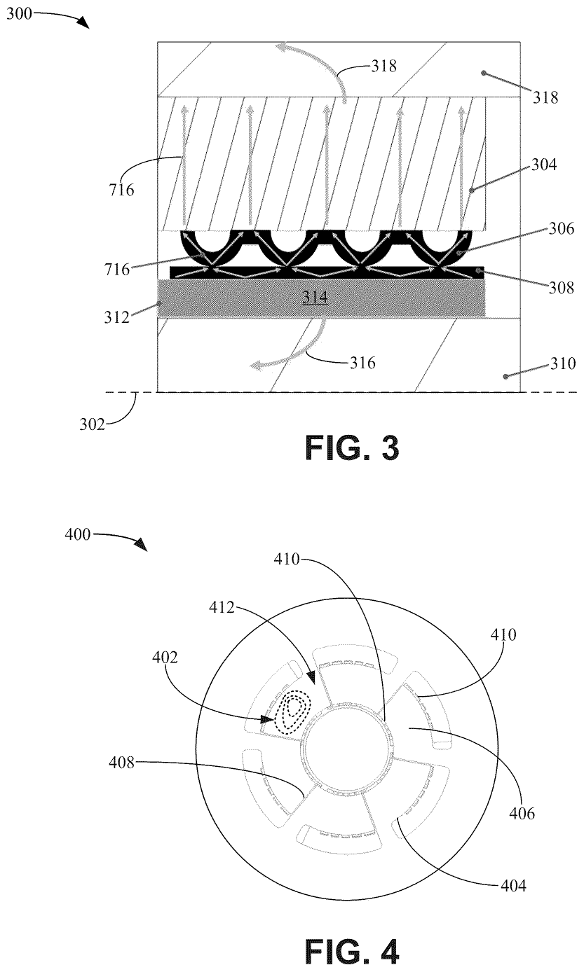

FIG. 3 is a schematic cross-section view illustrating heat flow in a gas foil bearing 300, according to some embodiments. There may be a substantial symmetry between an upper portion of bearing 300 above an axis 302 and a lower portion of the bearing below axis 302. Thus, the figure illustrates only the upper portion for clarity. Also, dimensions of the various parts of bearing 300 are not necessarily illustrated to scale.

Gas foil bearing 300, which may be the same as or similar to any of bearings 110 or 124, includes a foil bearing housing 304, a bump foil 306, and a top foil 308. A central region may be occupied by a shaft 310, for example. A bearing cavity 312 comprises a gap between the shaft and top foil 308 and may fill with working fluid 314, which lubricates the bearings. During operation, the working fluid experiences frictional shear forces which lead to heating working fluid 314.

Gas foil bearing 300 is an illustrative example of a method and mechanism for optimizing passive thermal management by conducting the heat from the bearing gap to the alternator housing via conduction through the gas foil bearing top foil and bump foil structure. For example, top foil 308 is in contact with fluid 314 in bearing cavity 312. The back side of the top foil is in contact with bump foil 306. Heat may flow through top foil 308 to bump foil 306, which is in contact with bearing housing 304, which then may conduct the heat to the turboalternator housing, for example.

An arrow 316 indicates heat flow from the working fluid into shaft 310. This heat flow is among other paths of flow that allow for cooling the working fluid. For example, arrows 318 indicate other paths of heat flow via top foil 308, bump foil 306, foil bearing housing 304, and a turboalternator housing 318, which may be the same as or similar to housing 106. Such thermally conductive paths allow heat to escape the working fluid in the bearing cavity and may eliminate a need for a cooling fluid to circulate through the bearing cavities, as in the case for turboalternator 100, for example.

In some implementations, the thickness of the foils, the positioning, quantity, and orientation of bump elements, and the material of the foils may be optimized to enhance thermal conduction. For example, regarding the material used for the foils, the gas foil bearing may generally use an Inconel alloy or stainless steel as the material for bearing foils due to their high strength and relatively low cost. However, to improve thermal conduction through the bearing foils, the gas foil bearings described herein may instead use metal alloys with high thermal conductivity and high strength, such as copper-nickel-silicon alloys (Cu—Ni—Si) or beryllium-copper alloys (Be—Cu). For example, beryllium copper (Be—Cu) has moderate thermal conductivity, which is not as high as some other metals like pure copper or aluminum, but it may nevertheless be a good choice where a balance of thermal conductivity, mechanical strength, wear resistance, and ability to resist deformation at elevated temperatures is important. Conductivity of beryllium copper is typically around 105 to 125 W/m·K, depending on the specific alloy composition.

Tungsten and molybdenum alloys may also be used for bump foils and top foils, though their weight and cost might make them less ideal for applications where lightweight materials are preferred. Aluminum may be used for the top foil 308 in implementations that prioritize thermal conductivity while not requiring as much mechanical strength. Thus, bump foil 306 and/or top foil 308 may comprise beryllium copper, an aluminum alloy, or a tungsten/molybdenum alloy. In particular implementations, for the sake of improved thermal conductivity, bump foil 306 and/or top foil 308 may not be made primarily of Inconel, a titanium alloy, or stainless steel.

FIG. 4 is an axial view of a gas foil thrust bearing 400 and illustrates example isotherms 402 on a top foil 404, according to some embodiments. Gas foil thrust bearing 400 may be the same as or similar to gas foil thrust bearing 124. for example. Top foil 404 includes pads 406 that are partitioned by gaps 408 to provide a degree of resilience that allows the bearing to adapt to thermal expansion or variations in load. Bump foil 410, portions of which are partially visible beneath the top foil pads 406, provides elastic support and absorbs mechanical stresses during operation. The flexibility of bump foil 410 also allows the whole bearing structure to adapt to thermal expansion or variations in load.

As explained above, a top foil may generally operate with a high pressure zone and a low pressure zone. For example, top foil 404 includes regions that, during operation, may be subjected to varying pressure, wherein certain regions experience higher pressure and other regions experience lower pressure. During operation, higher pressure may correspond to a higher temperature and lower pressure may correspond to a lower temperature. Isotherms 402 illustrate an example temperature profile inside the bearing gap (e.g., 312) for a gas foil thrust bearing. Accordingly, such a temperature profile may correspond to a pressure profile. Using such profiles (e.g., based on isotherms or isobars), high pressure-high temperature zones and low pressure-low temperature zones may be identified (e.g., the locations thereof).

Isotherms 402 indicate that temperatures tend to be highest at or near the center of top foil pads 406. For example, the center-most isotherm includes the highest temperature. The location of the relatively high temperatures (including the maximum temperature) coincides with the location of the relatively high (e.g., maximum) pressures in the bearing gap. Thus, isotherms 402 indicate the location(s) of high pressure-high temperature zones of top foil 404. In contrast, other portions of top foil 404, such as locations that would include lower temperature isotherms, if they were illustrated for lower temperatures, may include low pressure-low temperature zones 412 of top foil 404.

To optimize heat conduction through the thrust bearing foil structure, bump foil 410 may be configured to have a larger area of contact with top foil 404 in the high pressure zone (e.g., 402) as compared to a small area of contact with the top foil in the low pressure zone (e.g., 412).

In some implementations, as explained below, the larger area of contact of the bump foil with the top foil comprises bumps that are among valleys of the bump foil. In other implementations, the larger area of contact of the bump foil with the top foil comprises bumps that are between or among cutouts of the bump foil. In other words, dimensions and placement of bump foil elements may be selected to ensure relatively large contact area with the top foil pads at the location of the higher temperatures (and higher pressures), and smaller contact area at the locations with lower temperatures (and lower pressures).

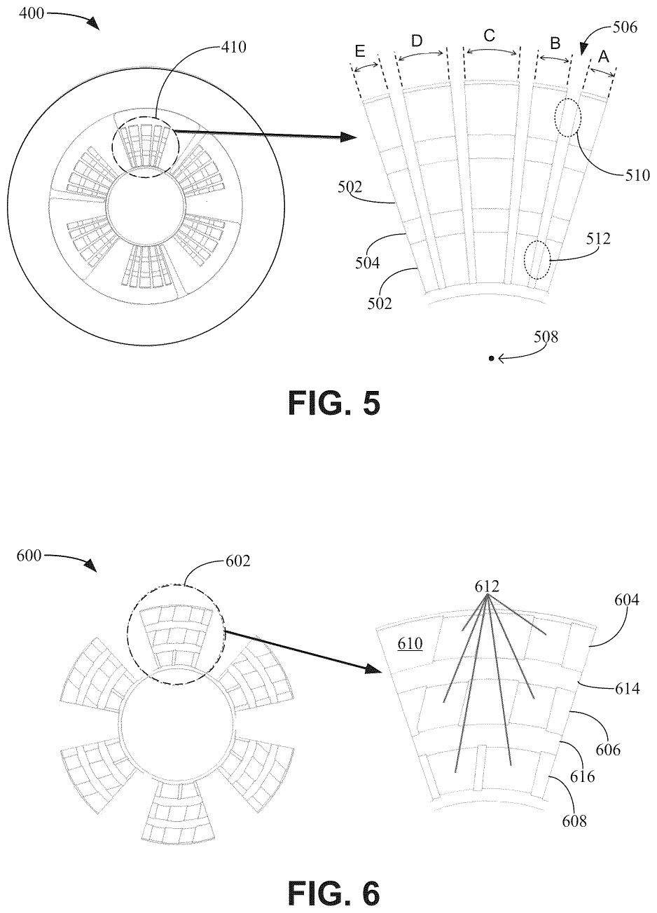

FIG. 5 is an axial view of gas foil thrust bearing 400 without top foil 404, so as to provide a detailed view of bump foil 410, according to some embodiments. Top foil 404 may include a number of elements that are distributed in a circumferential and radial direction. As mentioned above, the location of the maximum temperatures coincides with the location of the maximum pressures in the bearing gap. Thus, to optimize heat conduction through the thrust bearing foil structure, the bump foil elements may be sized and placed so that a relatively large area of contact with the top foil is at locations with the higher temperatures (and higher pressures) and a relatively small area of contact with the top foil is at locations with the lower temperatures (and lower pressures).

Bump foil 410 includes bump foil elements A, B, C, D, and E, each having widths that may be different from widths of the other bump foil elements. For example, the width of each bump foil element may be selected so as to have a larger contact area with the top foil at higher temperature locations and a smaller contact area at lower temperature locations, as explained above. In addition to varying widths of the bump foil elements, sizes of individual bumps 502 and valleys 504 may also be designed or selected for a desired location and size of contact with the top foil as well as for a desired foil deflection under load.

In some implementations, bump foil 410 includes radial cutouts 506 that may have widths that correspond to widths of bump foil elements A, B, C, D, and E. For example, the cutouts may progressively widen with increasing distance from the axial center 508 of the thrust bearing. In other words, a width of cutout 506 in region 510 may be larger than a width of cutout 506 in region 512.

As described above, to optimize heat conduction through a bearing foil structure, a bump foil may be configured to have a larger area of contact with a top foil in a high pressure zone (e.g., 402) as compared to a smaller area of contact with the top foil in a low pressure zone (e.g., 412). Accordingly, in some embodiments, a gas foil bearing, such as thrust bearing 400, may comprise top foil 404 that includes a high pressure-high temperature zone and a low pressure-low temperature zone. Bump foil 410 may include i) first bumps among bumps 502 that are in contact with the high pressure-high temperature zone, ii) second bumps among bumps 502 that are in contact with the low pressure-low temperature zone, and iii) valleys 504 that partition each of the first bumps and each of the second bumps from one another. The sizes of the first bumps may be larger than sizes (or the sums of the sizes) of the second bumps. The thermal conductivity (between the top foil and the bump foil) provided by the first bumps may be larger than the thermal conductivity provided by the second bumps. At least some of the valleys may comprise cutouts or slots, such as 506, in the bump foil. For embodiments involving a thrust bearing, the cutouts or slots may progressively widen with increasing distance from the axial center (e.g., 508) of the thrust bearing. The cutouts or slots may be aligned in a radial direction from the axial center of the thrust bearing.

In some implementations, each of bump foil elements A, B, C, D, and E may comprise a metal strip that extends from axial center 508 to a perimeter of the bump foil. The metal strip includes high portions and low portions corresponding, respectively, to bumps 502 and valleys 504. In other implementations, instead of being low portions of the metal strip, valleys 504 may be discontinuities (e.g., cutouts) in the metal strip. For example, bumps 502 may be separated by a cutout, corresponding to 504, such that each bump 502 is made of separate sections of metal. Claimed subject matter is not limited to any particular configuration of bumps and valleys, regardless of whether the valleys are cutouts in metal of low portions of the metal.

FIG. 6 is an axial view of a gas foil thrust bearing 600 without a top foil, so as to provide a detailed view of bump foil 602, according to other embodiments. Bump foil 602 is similar to bump foil 410 with a difference in bump-valley configuration and lack of radial cutouts such as 506. For example, bump foil 602 may include bump foil elements 604, 606, and 608, each being a circumferential metal strip that includes bumps 610 and valleys 612, which may be cutouts (e.g., discontinuities) in the metal strips, such as those described above. Bump foil elements 604, 606, and 608 may be partitioned from one another by circumferential gaps or cutouts 614 and 616.

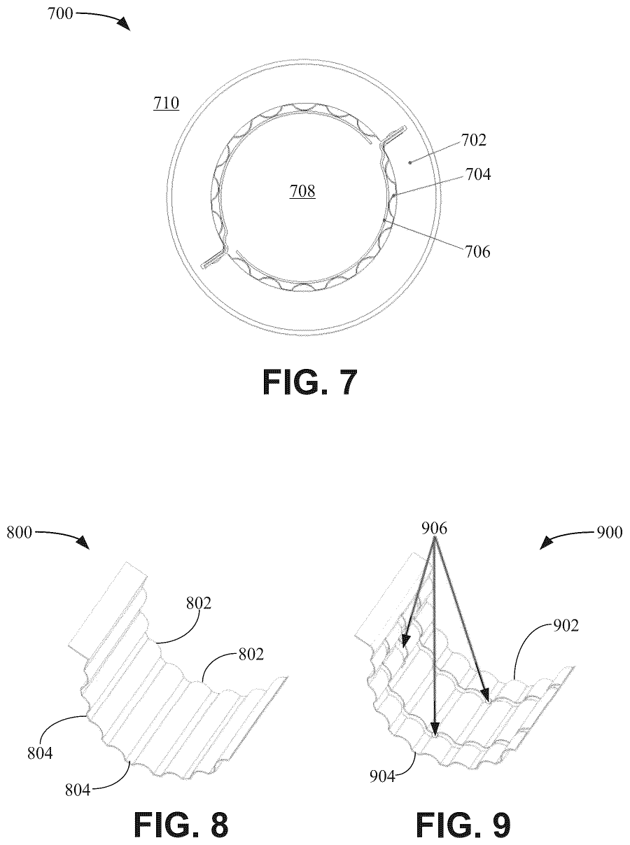

FIG. 7 is an axial view of a gas foil journal bearing 700, according to some embodiments. Journal bearing 700 may be similar to or the same as 110 in turboalternator 100, for example. Bearing 700 includes a foil bearing housing 702, a bump foil 704, and a top foil 706. A central region 708 may be occupied by a shaft such as 102, for example. Bearing cavities, such as 130, may comprise a gap between the shaft and top foil 706. In some implementations, this gap may be less than one thousandth of an inch, though claimed subject matter is not limited in this respect. These bearing cavities, including spaces surrounding bump foil 704, may fill with working fluid, which lubricates the bearings and provides a near frictionless interface between the shaft and the top foil. Generally, for a turboalternator, the working fluid may also function as a cooling fluid for the bearing, which generates friction-based heat (e.g., from fluid shear) during its operation. For turboalternator 700, the working fluid need not function as a flowing heat-carrying cooling fluid for the bearing because the heat generated therein may be thermally conducted away via the material (e.g., 108) of turboalternator housing 710 (e.g., 106), as explained below.

FIG. 8 is a perspective view of a bump foil 800 of gas foil journal bearing 700, according to some embodiments. Bump foil 800, which may be the same as or similar to bump foil 704, includes bumps 802 and valleys 804.

FIG. 9 is a perspective view of a bump foil 900 of gas foil journal bearing 700, according to some embodiments. Bump foil 900, which may be the same as or similar to bump foil 704, includes bumps 902, valleys 904, and cutouts 906. In some implementations, cutouts 906 may be aligned circumferentially with respect to the axial center of the journal bearing.

As described above, to optimize heat conduction through a bearing foil structure, a bump foil may be configured to have a larger area of contact with a top foil in a high pressure zone as compared to a small area of contact with the top foil in a low pressure zone. Top foil 706 of journal bearing 700 may include a high pressure-high temperature zone and a low pressure-low temperature zone, such as those described for top foil 404. Bump foil 900 may include i) first bumps among bumps 902 that are in contact with the high pressure-high temperature zone, ii) second bumps among bumps 902 that are in contact with the low pressure-low temperature zone, and iii) valleys 904 or cutouts 906 that partition each of the first bumps and each of the second bumps from one another. The (sum of the) sizes of the first bumps may be larger than the (sum of the) sizes of the second bumps. The thermal conductivity provided by the first bumps may be larger than the thermal conductivity provided by the second bumps.

Cutouts 906 and/or valleys 904 may be sized and placed in the bump foil structure to provide relatively high thermal conductivity and desired top foil deflection. For example, particular cutout configurations may give rise to uniform temperatures in the bearing film (e.g., in the bearing cavity) by optimizing heat conduction through bump foil elements. The cutouts may also help to ensure a uniform bearing gap because the areas on the top foil experiencing higher pressures can have more bump foil support thereunder. Thus, the top foil deflection due to bearing film pressure may be substantially uniform.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments or examples are presented by way of examples for purposes of illustration and description. They are not intended to be exhaustive of or to limit this disclosure to the precise forms described. Many modifications and variations are possible in view of the above teachings. The embodiments or examples are shown and described in order to best explain the principles of this disclosure and practical applications, to thereby enable others skilled in the art to best utilize this disclosure and various embodiments or examples with various modifications as are suited to the particular use contemplated. It is intended that the scope of this disclosure be defined by the following claims and their equivalents.

We claim as follows:

1. A gas foil bearing comprising:
a top foil including a high pressure zone and a low pressure zone, wherein the high pressure zone includes areas of the top foil that are configured to operate at a first pressure and a first temperature and the low pressure zone includes areas of the top foil that are configured to operate at a second pressure and a second temperature, and wherein the first pressure and the first temperature are larger than the second pressure and second temperature; and
a bump foil that is configured to have a larger area of contact with the top foil in the high pressure zone as compared to a small area of contact with the top foil in the low pressure zone.

2. The gas foil bearing of claim 1, wherein the larger area of contact of the bump foil with the top foil comprises bumps of the bump foil, the bumps being among valleys of the bump foil.

3. The gas foil bearing of claim 1, wherein the larger area of contact of the bump foil with the top foil has a larger thermal conductivity as compared to a thermal conductivity of the small area of contact of the bump foil with the top foil.

4. The gas foil bearing of claim 1, wherein the larger area of contact of the bump foil with the top foil comprises bumps of the bump foil, the bumps being between or among cutouts of the bump foil.

5. The gas foil bearing of claim 4, wherein the gas foil bearing is a thrust bearing.

6. The gas foil bearing of claim 5, wherein the cutouts progressively widen with increasing distance from the axial center of the thrust bearing.

7. The gas foil bearing of claim 5, wherein the cutouts are aligned in a radial direction from the axial center of the thrust bearing.

8. The gas foil bearing of claim 4, wherein the gas foil bearing is a journal bearing.

9. The gas foil bearing of claim 8, wherein the cutouts are aligned circumferentially with respect to the axial center of the journal bearing.

10. The gas foil bearing of claim 1, wherein the bump foil comprises beryllium copper.

11. The gas foil bearing of claim 1, wherein the bump foil comprises an aluminum alloy or a tungsten/molybdenum alloy.

12. The gas foil bearing of claim 1, wherein the bump foil is not made primarily of Inconel, a titanium alloy, or stainless steel.

13. A gas foil bearing comprising:
a top foil including a high pressure-high temperature zone and a low pressure-low temperature zone; and
a bump foil including i) first bumps in contact with the high pressure-high temperature zone of the top foil, ii) second bumps in contact with the low pressure-low temperature zone of the top foil, and iii) valleys that partition each of the first bumps and each of the second bumps from one another, wherein sizes of the first bumps are larger than sizes of the second bumps.

14. The gas foil bearing of claim 13, wherein thermal conductivity provided by the first bumps is larger than thermal conductivity provided by the second bumps.

15. The gas foil bearing of claim 13, wherein at least some of the valleys comprise cutouts or slots in the bump foil.

16. The gas foil bearing of claim 15, wherein the gas foil bearing is a thrust bearing.

17. The gas foil bearing of claim 16, wherein the cutouts or slots progressively widen with increasing distance from the axial center of the thrust bearing.

18. The gas foil bearing of claim 16, wherein the cutouts or slots are aligned in a radial direction from the axial center of the thrust bearing.

19. The gas foil bearing of claim 15, wherein the gas foil bearing is a journal bearing.

20. The gas foil bearing of claim 19, wherein the cutouts or slots are aligned circumferentially with respect to the axial center of the journal bearing.
